(19) United States
(12) Patent Application Publication
(10) Pub. No.: US 2009/0187472 A1
(43) Pub. Date: Jul. 23, 2009

(54) APPARATUS AND METHOD FOR PRODUCING PERSONALIZED COSMETIC PRODUCTS

(75) Inventor: Joseph MELOUL, Omer (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: EESHEE COSMETICS LTD, OMER (IL)

(21) Appl. No.: 12/351,869

(22) Filed: Jan. 12, 2009

Related U.S. Application Data
(60) Provisional application No. 61/006,509, filed on Jan. 17, 2008.

(51) Int. Cl. G06Q 50/00; G06Q 99/00; G06F 7/06; G06F 19/00; G06F 17/30

(52) U.S. Cl. 705/10; 705/1; 707/3; 700/107; 707/E17.014

(57) ABSTRACT

An apparatus and method of manufacturing a personalized cosmetic product, said method comprising, receiving data relating to a person; obtaining a predefined list of items and determining at least one item to be used in manufacturing the personalized cosmetic product according to the data relating to a person. The apparatus containing a computerized device for analyzing the received personalized data according to the list of items.

### BACKGROUND OF THE INVENTION

1. Field of the Invention

The present invention generally relates to production of personal cosmetic products, and more particularly, to an apparatus and method for manufacturing personal cosmetic products according to data received from a person.

2. Discussion of the Related Art

Cosmetic compounds, mixtures and suspensions for cosmetic products such as skin regeneration and rejuvenation products, skin protection products, beauty products, soaps, deodorants and the like are well known in art. Cosmetic products for treating skin, hair nails are marketed around the world under well known brands, thus providing the same products for different customers world-wide. The cosmetic products are manufactured in mass production that enables efficient production of cosmetic products in large quantities.

Such production line comprises a bulk production of cosmetic using ingredients such as synthetic and natural chemicals that are mixed in a predetermined manner. The production line economizes the cost production per gram of cosmetic products. The predetermined manner of manufacturing a bulk of cosmetic products could be heating and cooling the ingredients, mixing the ingredients according to a predetermined order, processing the ingredients under superficial conditions and the like.

Cosmetic products manufactured by mass production must be suitable for use by a variety of users. Thus, for example, a skin care cream product of mass production must be suitable for different skin types, for example to both dry and normal skin, tanned or pale skin, and the like. Consequently, the usefulness of such cream is limited for some users to a certain degree. For example, some users can find a cosmetic product produced using a production line very useful, while other users can find that the cream provides insignificant results. As a result, the larger the number of potential users, the lesser is the effect of cosmetic products, due to the manner of mass production of the products.

There is therefore a need to enable production of cosmetic products that are personally suited to a user. There is further a need to provide a user with a product that analyzes the specific cosmetic treatment and care that fit the user. Furthermore, there is a need to provide a fast production line for such personalized cosmetic product, cream or treatment.

### SUMMARY OF THE INVENTION

It is an object of the subject matter to disclose a production facilitating apparatus enabling manufacturing of at least one cosmetic product or treatment for use by a person, the apparatus comprising, an input device for receiving data relating to the person, a processing element for determining the cosmetic product or treatment according to the data relating to the person.

In some embodiments, the apparatus further comprises a database comprising list of ingredients used to manufacture the cosmetic product according to the data relating to the person.

In some embodiments, the apparatus further comprises an output device for notifying the person of the cosmetic product determined by the processing element.

In some embodiments, the apparatus is adapted to provide at least one list of comprising the quantity of the ingredients for manufacturing at least one personal care compound.

In some embodiments, the apparatus is adapted to provide at least one formula for manufacturing at least one personal care compound.

It is another object of the subject matter to disclose a production apparatus for manufacturing of a cosmetic product, the apparatus comprises a storage containing ingredients used to manufacture the cosmetic product; an input device receiving a command relating to the ingredients; a mechanical instrument for removing the ingredients from the storage, such that said ingredients are ready to be used for manufacturing the cosmetic product;
wherein the command is a function of data relating to a person according to which the cosmetic product is manufactured.
In some embodiments, the ingredients are stored in capsules within the storage. In some embodiments, the capsules are stored within a cassette, each cassette comprises capsules containing the same ingredients.

It is another object of the subject matter to disclose a method of manufacturing a personalized cosmetic product, said method comprises receiving data relating to a person, obtaining a predefined list of items and determining at least one item to be used in manufacturing the personalized cosmetic product according to the data relating to a person.

In some embodiments, the method further comprises a step of providing an assessment to the person from which the data is received

In some embodiments, the method further comprises a step of receiving user approval of the determined at least one item.

### BRIEF DESCRIPTION OF THE DRAWINGS

The present invention will be understood and appreciated more fully from the following detailed description taken in conjunction with the drawings in which:

FIG. 1 shows an apparatus for providing a personalized cosmetic product, according to one exemplary embodiment of the disclosed subject matter;

FIG. 2 shows components within a computing device such as computing device 12 of FIG. 1, according to an embodiment of the present invention;

FIG. 3 shows a production unit for producing a personalized cosmetic product, according to some exemplary embodiments of the disclosed subject matter; and,

FIG. 4 shows a flow of a method of producing cosmetic product using to personalized data, according to some exemplary embodiments of the subject matter.

### DETAILED DESCRIPTION OF THE PREFERRED EMBODIMENT

The present invention provides a production facility apparatus and a method for manufacturing a personalized cosmetic product. The apparatus comprises a launcher to provide the personalized cosmetic product and a computing device providing instructions of ingredients required for the manufacturing of the product. The launcher comprises cartridges with capsules including ingredients. The computing device comprising an input device for receiving personal cosmetic related data and a database that enables analysis of the personal cosmetic related data and provides a list of ingredients and instructions required for a production of at least one cosmetic product.

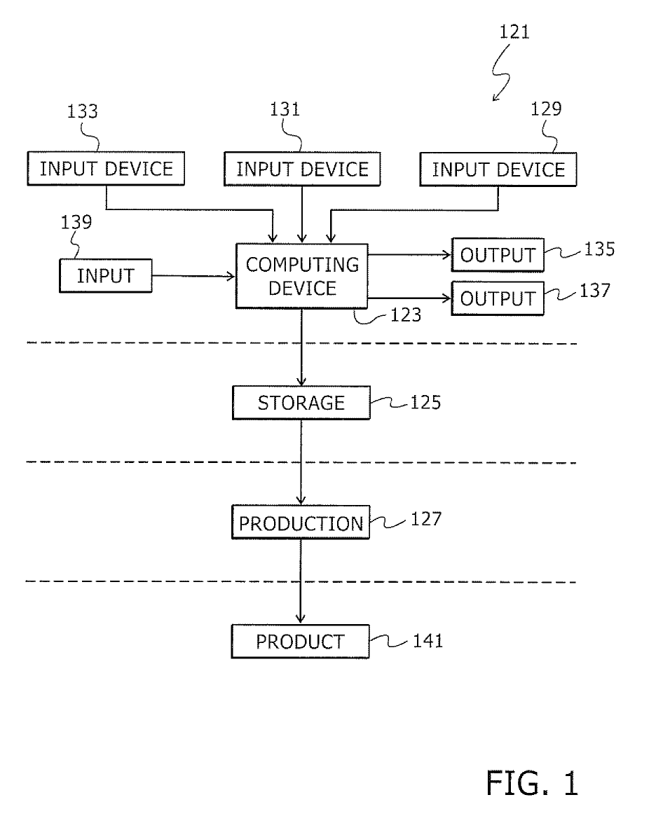

FIG. 1 shows an apparatus for providing a personalized cosmetic product, according to one exemplary embodiment of the disclosed subject matter. Apparatus 121 comprises input devices such as 129, 131, 133, 139, a computing device 123, two output devices 135, 137, a storage 125, and a production module 127. Apparatus 131 is capable of providing a cosmetic product 141 at the end of the process, upon order from a user. Apparatus 131 provides a cosmetic product such as the cosmetic product 141 that is adapted to personalized data entered to apparatus 131 using one or more of the input devices 129, 131, 133, 139. Input devices 129, 131, 133, 139 may be keyboard, a touch screen monitor, a plurality of buttons, switches, or other means capable of capturing or receiving audio or video data. In some embodiments of the disclosed subject matter, one input device may be a skin pH probe. Other probes desired by a person skilled in the art may also be used. Computing device 123) may be a PC computer, server computer, or any computerized module having processing capabilities to process data received from the input devices 129, 131, 133, 139. The computing device 123 may alternatively consist of an input or output device, receive the personal cosmetic related data, transmit said data to an adaptive server located outside the apparatus 131, for example using the internet or an RE channel, and receive the results or assessment from the server (not shown). Output devices 135, 137 may be a printer, a screen, amplifier, loudspeaker and the like. The use of the input devices 129, 131, 133, 139 is to provide personal data to the computing device 123 or to the server (not shown). The insertion of personal data may be performed by an operator of the apparatus 131 or independently by a user (not shown) who wishes to receive a personalized cosmetic product from the apparatus 131.

Typically, the computing device 123 comprises more than one input device enabling insertion of data from user including filling in a questionnaire providing personal data relating to the user's profession, environment, geographical climate, visual observation of the skin such as skin color and level of redness, personal data like age, education, residence, known allergies, smoker/non-smoker, personal preferences of the user and the like. A questionnaire can be filled directly to the computing device 123 using an input device such as 129, 131, 133, 139. An input device may be a touch screen, a keyboard, means that use voice recognition methods and the like. The questionnaire may alternatively be printed, filled and scanned to the computing device 123. Further information can be provided by a probe (not shown) sensing the user's skin. The probe (not shown) may provide information relating to the user's skin. Next, additional information relating to the user's skin is inserted to the computing device 123.

Consequently, the information accumulated regarding the user's skin and environment provides sufficient data for the computing device 123 to provide analysis or assessment of the skin's condition. Such assessment may be the basis for recommendations for personal cosmetic products that fit the user's needs, according to previously inputted data. The cosmetic product may be cream, emulsion, powder, paste and the like, and may provide for skin protection, hair beauty product such as hair conditioner, beauty products, non-medical cosmetic products such as makeup, lipstick, mascara, eyeliner and the like.

The analysis and recommendations are provided to the user (not shown) using the output devices 135, 137. The output may be provided in a paper form printed off the apparatus 131 or viewed on a screen. Other embodiments can provide an audio speaker reading out the analysis and recommendations using pre-recorded data selected by the computing device 123. The assessment provided is a result of analysis preformed by the computing device 123. Computing device 123 provides assessments and recommendations for skin or cosmetic treatment or product based on interpretation and analysis of the data inserted to the computing device 123.

In accordance with some exemplary embodiments of the disclosed subject matter, the computing device 123 comprises a table of optional items to be included within a cosmetic product. The cosmetic product is prepared for a particular person in accordance to previously inserted data relating to said person. Each item may have a code representing a potential ingredient of a cosmetic product, such as a material, predefined mixture and the like. Some of the items include a number of ingredients. The quantity of each item is listed in a storage 125 in the computing device 123.

Typically, each cosmetic product produced by the apparatus 131 comprises a base section and a customized section. The base section is a section of a product that can be found in a large number of products aimed to treat similarly categorized skins. Thus, for example, various personal creams for treating dry skin will generally comprise a similar base section. The customized section will vary according to the personal data input. In some embodiments of the subject matter, each item is located in a separated capsule having a specific volume. The capsules are stored in the storage 125. In some embodiments of the disclosed subject matter, storage 125 comprises a vast variety of items, and combinations of conventional items, in different relations and concentrations. Upon receipt of a demand from the user, or a command from the computer device 123, the apparatus may create new cosmetic products using the items and combinations stored in the storage 125. In some cases, each item has a predetermined relation between its ingredients. Thus, once the analysis of a user's skin is finalized, one or more personal cosmetic products are recommended by the computer device 123. Each product recommended to the user correlates to the previously inputted personal data. In some cases, an indication is provided of a priority required for a treatment or product. For example, a user's skin that requires immediate moisturizer and redness treatment will be indicated in top priority. Further recommendations with lower priorities will be indicated as well. Some of the input devices 129, 131, 133, 139 enable a user to indicate and choose the desired cosmetic product from the production section. Thus, a list of recommended cosmetic products with different priorities for treating different aspects of the assessment are provided. As a result, the user can insert the choice or choices of cosmetic product via the input devices 129, 131, 133, 139.

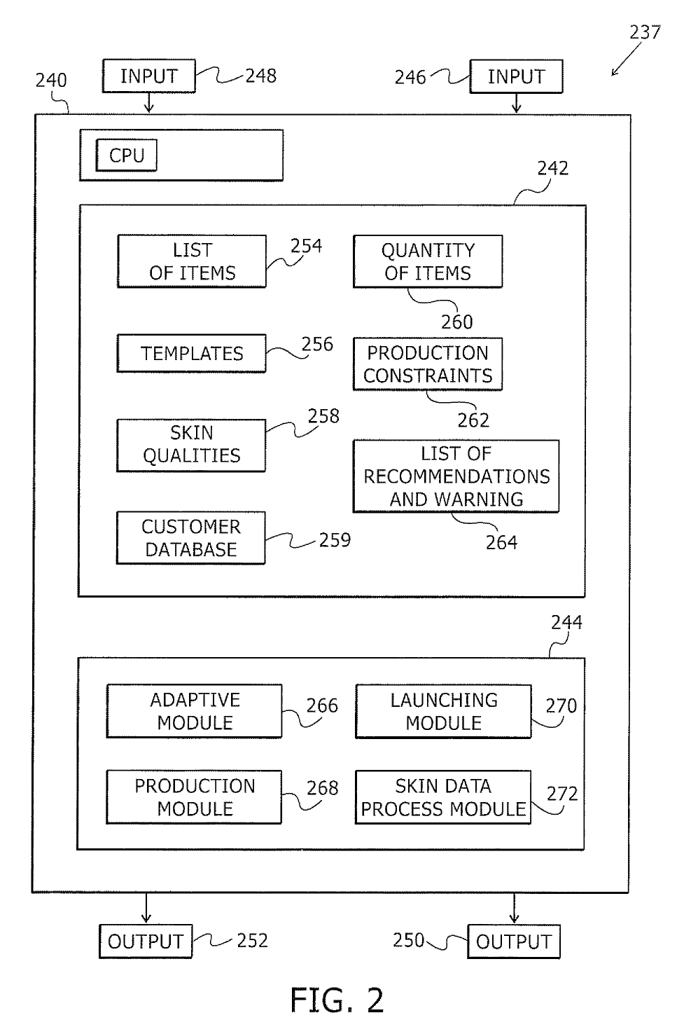

FIG. 2 shows components within a computing device similar to computing device 12 of FIG. 1, according to an embodiment of the present invention. Computing device 237 comprises input devices 246, 248, output devices 250, 252 and other elements that can be in ordinary personal computers. Additionally, computing device 237 comprises a database element 242, and operational element 244. Database element 242 comprises a number of databases or storage units containing data used to produce a personalized cosmetic product or treatment according to data related to a person or a group of persons. Such databases or storage units may contain a list of items 254, templates storage 256, list of skin qualities 258, customer database 259, quantities of items 260, production constrains 262, and list of recommendations and warnings 264. Other lists, tables, databases and storage units may be provided as desired by a person skilled in the art. In some exemplary embodiments, at least some of the modules within the computing device 237 reside outside the apparatus 131 and communicate with the apparatus 131. The list of items 254 comprises a list of items that can be used for production of cosmetic products or treatments, such as mixtures, liquids, pastes, creams, elements from the periodic table and the like. The data items in the list of items 254 may be arranged in libraries, folders, and can be manipulated by the computing device or by the operational elements disclosed below. Such manipulation may contain reviewing mixtures of various items of the list of items, reviewing mixtures having different concentrations, reviewing the results of such mixtures, reviewing the results of using said mixtures and the like. Manipulation of said data enables creation of a vast amount of new cosmetic products using the items known in the art, according to the personalized data. Templates storage 256 comprises template data for production of cosmetic products correlating to different possible assessments of skin condition and required treatment. Typically, the templates storage 256 comprises a base section comprising elements such as water, citric acid, lactic acid, tea tree oil, vitamin E, coconut and the like. List of skin qualities 258 comprises different possible skin analysis and assessment results, such as level of redness, required treatment, recommended beauty product, color that fit the data inputted by the user and the like. Customer database 259 comprises data related to customers' history, such as personal data, assessments and analysis provided by the apparatus 131, recommended cosmetic products and cosmetic products selected by customers, dates, age, residence, gender, financial and transactional history, coupons, discounts and the like.

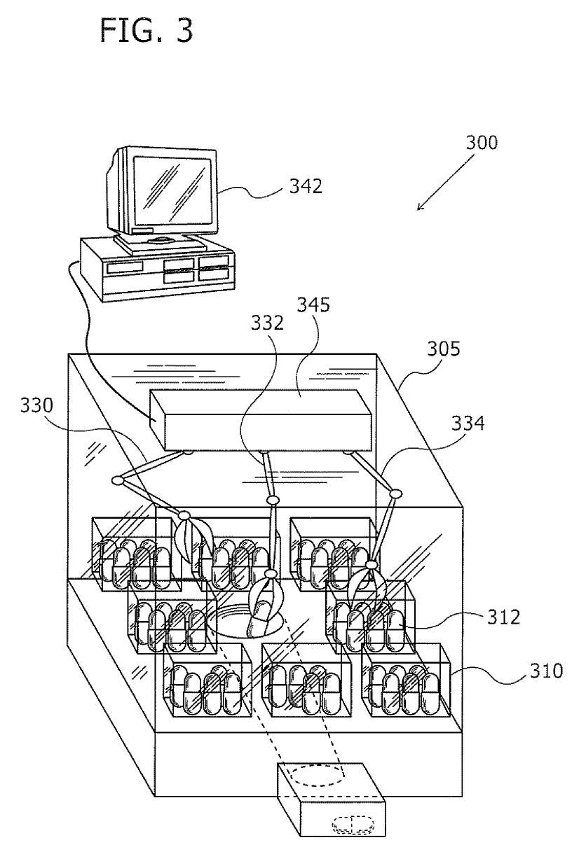

List of quantity of items 260 comprises a list of ingredients and the quantity or percentage required for the production of each item. The quantity may be measured in weight, volume and number of capsules stored in the apparatus 131. Production constrains 262 comprises a list of constrains relating to production of cosmetic products from the list of items 254. For example, mixing limitation applying to the homogony of a cream, restricted items according to data inputted by the user such as allergies, restricted materials due to level of redness, age, forbidden combinations that provide insufficient mixtures and the like. Computer device 237 may implement software or hardware modules written in a programming language such as Java, C#, C++ and the like. The production of the personalized cosmetic product such as product 141 may be implemented using the production unit disclosed in details in FIG. 3. The data in the databases disclosed above may be stored in magnetic disks, volatile memories, RAM and the like.

Operational element 244 comprises modules enabling the operation of the computing device 237 according to some exemplary embodiments of the disclosed subject matter. Skin data process module 272 processes the personal data inputted by the user. In some cases, skin data process module 272 communicates with the customer database 259 and analyses the data using skin qualities 258 and the list of recommendations and warnings 264 to provide assessments for a customer. Adaptive module 266 correlates the assessment of a customer, for example the assessment provided by the skin data process module 272, to determine materials and mixtures that can be used to produce the personalized cosmetic product according to the list of items 254. Production module 268 provides the production capability in view of data stored in the list of items 254 and the quantity of items 260 while taking into account the data stored in the production constrains 262 and template storage 256. Launching module 270 provides the data related to the actual production of the personalized cosmetic product or treatment, such as production capability, taking into account data provided by other modules mentioned above, both operational modules and database modules. Determinations provided by the operational module 244 of the computing device 237 may be sent to a production module 268 communicating with the production unit disclosed in FIG. 3.

FIG. 3 shows a production unit for producing a personalized cosmetic product or treatment, according to some exemplary embodiments of the disclosed subject matter. Production unit 300 comprises storage 305 that contains a plurality of capsules, such as capsule 312 that contain materials used to produce a personalized cosmetic product. Such material may be oil, liquid, paste, mixture or another product desired by a person skilled in the art. In many embodiments of the disclosed subject matter, the capsules are arranged and stored in one or more cassettes, such as cassette 310. The cassette 310 is limited to contain one type of capsule, to facilitate the operation of the production unit 300.

The production unit 300 may also comprise one or more mechanical instruments such as arms 320, 322 to push or pull one or more capsules from the storage 305, or alternatively removing capsules from the cassette 310. The arms 320, 322 are connected to a power generator 340, and to a computing device 342. Such computing device 342 transmits information to a control unit 345 communicating with the arms 320, 322, 324 that determines the movement of the arms 320, 322, 324. Alternatively, the mechanical instrument may be a set of springs that push a capsule from the storage 305, bars that prevent capsules from dropping off the storage 305 and the like. The capsules may be opened by an opener (not shown) that cuts one end of the capsule to allow removal of the content of the capsule. Alternatively, a piston (not shown) presses the capsule that opens as a result of the pressure, and allows removal of the content of the capsule. Such piston may also be used to push the content of the capsule from the capsule after the capsule's end is removed by the opener. In some exemplary embodiments of the disclosed subject matter, the material used to produce a personalized cosmetic product or treatment is stored in refillable containers, not in capsules. Such containers may be contains a significantly larger amount of content, compared to the capacity of a capsule. For example a container may contain 500 cc, while a capsule may contain 12 cc, removal of content from such containers may be performed according to a command from a control unit, such as the control unit 345. As a result, a predefined amount of material is removed from the container. Such predefined amount may be scaled by a scale, to detect and verify that the amount is as required. The content of the container may be removed by maneuvering a barrier that prevents a material to drop off the container. The exact maneuver and the time for allowing removal of the material may be predetermined, or preprocessed, as desired by a person skilled in the art.

The capsules may be of different sizes, thus enabling to contain a different quantity of one or more items. The capsules may be of a polygonal or cylindrical shape that ends with a conical end on one side. Each capsule comprises one or more items. According to one embodiment, the cassettes are stored in a cabinet style structure and are organized according to sizes and items contained. Thus, each cassette comprises one type of capsules and each capsule within a cassette contains the same item.

In some exemplary embodiments of the disclosed subject matter, each cassette comprises a form holding the capsules that ends with a moveable gate at one end of a cassette. The opposite end of the form is mechanically pressed by a spring. The moveable gate is mechanically connected to a motor and gear present on each cassette. In this exemplary embodiment, the motor and gear (not shown) are electrically controlled by the control unit 345. In operation, when receiving approval of a user to produce the personalized cosmetic product or treatment, the computing device 342 provides the control unit 345 a list of items required for production. The motors controlling the gates of relevant cassettes comprising required items for production initiate the release of said capsules by maneuvering the gates. As a result, a capsule emerges from the cassettes due to the spring's pressure. Soon after a capsule exited a cassette, the gate is returned to place due to an action of the motor and rear. After the capsules are removed from the storage 305, they are emptied and the content is poured into a central vessel.

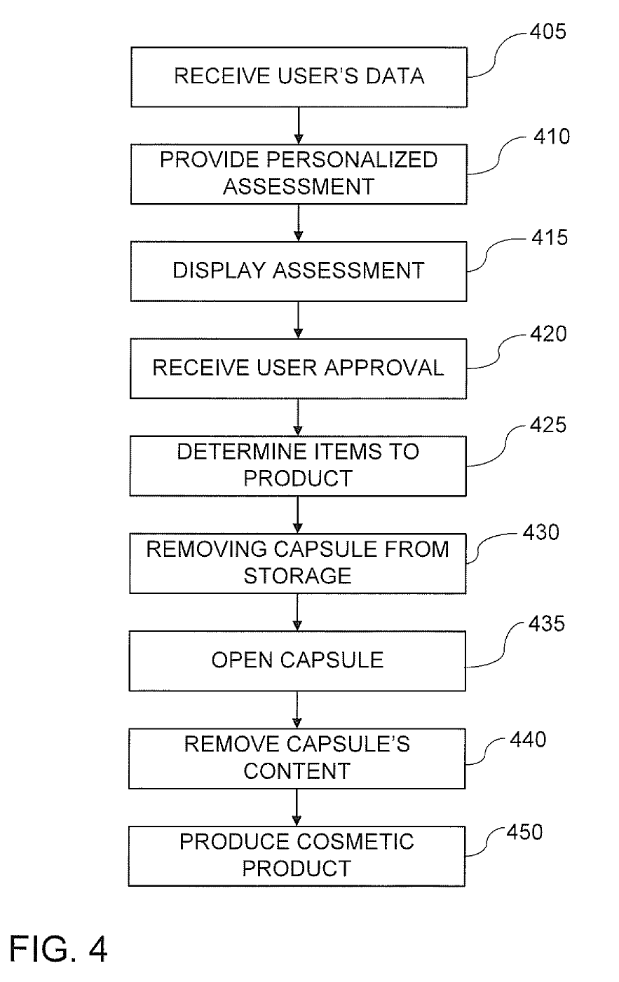

FIG. 4 shows a flow of a method of producing cosmetic product or treatment according to personalized data, according to some exemplary embodiments of the subject matter. Step 405 discloses receiving user personalized data related to the production of the cosmetic product or treatment. Such data may be age, physical condition, skin color, acne, redness, preferences, flavors, odors, colors, and the like. The user may input the personalized data via an input device such as keyboard, mouse, touch screen, button, switch and the like. The personalized data may be inputted into a multiple answer questionnaire, according to predefined questions, free text inputted by the user and the like. Some of the personalized data may be received using adaptive instruments, such as an image-capturing device, PH meter device and the like. The personalized data is likely to be stored in a computerized apparatus for further use by the same user. In some embodiments of the disclosed subject matter, access to inputting personalized data is provided only upon inputting username and password. Some of the personalized data may relate to financial status, payment method and the like. In some cases, the questions provided to the user are selected by a computerized device according to previous answers from the user. In some embodiments of the disclosed subject matter, some of the personalized data is provided in a printed document scanned by the computerized apparatus that receives the personalized data. Such computerized apparatus may be a personal computer, server, an input device connected to a personal computer or server, or a combination of the above.

In step 410, the apparatus disclosed in FIGS. 1 and 2 provides assessment to the user concerning the personalized cosmetic product. The assessment is provided according to the personalized data inputted by the user. Such assessment may be based upon items stored in the storage 305 disclosed in FIG. 3. For example, in case the optimal selection of items according to the user's preferences and medical condition require a specific item, such item may be provided in the assessment of step 410. In another exemplary embodiment, the next best selection is matched with items stored in the storage 305. The assessment may contain the optimal selection of items, in addition to a restricted selection of items, according to items stored in the storage. The assessment may contain graphically illustrated data, for example a graphical list of items arranged upon priorities and necessities of the user. The graph may contain the percentage, amount or volume of each item in a personalized cosmetic product selected for the user by the apparatus of the disclosed subject matter. In step 415, the assessment is provided to the user. Such provision may be performed via a display device, using a printer, via a loudspeaker and other output devices desired to a person skilled in the art.

In step 420, the computerized apparatus receives a response from the user concerning the assessment provided in step 415. Such response may be approval, such that a command from the computerized apparatus can be sent to the production unit. Alternatively, the response from the user may reject the proposed assessment and request another assessment. The user may input arguments for rejecting the proposed assessment if desired, using an input device as disclosed above. In case the assessment is rejected, the computerized apparatus provides another assessment, until the user approves the assessment or terminates the process, for example by logging out or not responding to the proposed assessment. In step 425, performed after receipt of approval from the user, the computerized apparatus determines the personalized cosmetic product to be manufactured to the user, based on the personalized data received from the user. Such determination may also refer to the amount and percentage of each item stored in storage 305 to be used in manufacturing the personalized cosmetic product. The determination may be a function of any data stored in any database disclosed in FIG. 2 or desired by a person skilled in the art.

In some cases, the determination may only refer to the number and size of capsules required for each material or mixture. For example, one large capsule of tea tree oil and three medium capsules of a mixture containing vitamin E. The amount of material may be affected by the size and package desired by the user, when inputting data received in step 410. The capsules may have different sizes and volumes as disclosed above. For example, a small capsule may have a capacity of 20 ml; a medium capsule may have a capacity of 30 ml and the like.

Typically, after the items and their volume or amount are determined, or once the specific capsules are determined, a command is transmitted to a mechanical instrument that removes, in step 430, the capsules from the storage 305. Such mechanical instrument may be mechanical arms, maneuvered upon computerized command towards a specific storage of a specific capsule for removing such capsule from the specific storage. Other mechanical instruments are disclosed in FIG. 3, for example a spring activated upon a computerized command, to push a specific capsule. Alternatively, the storage of a specific capsule may change its direction, such that capsules may slip downwards to a main container where the material within the capsules is to be handled. In some cases, more than one mechanical instrument is operable in removing more than one capsule from the storage. For example, three arms operating simultaneously to remove three different capsules from the storage.

Step 435 is optional and performed after the capsules are removed from the storage. In order to remove the content of the capsules from the capsules, one method requires opening the capsules using a capsule opener. Such opening may be performed by removing one end of the capsules, cutting a portion of the capsule and the like. Other methods to enable removal of the capsule's content may be provided by the person skilled in the art. In an alternative embodiment, the content is not stored in a rigid capsule, but in a large container having an outlet such that removal of the content from the container may be provided by maneuvering a barrier connected to the outlet of the container.

In step 440, the capsule's content is removed from the capsule. The removal may be provided using a mechanical tool such as a piston that pushes the content outside tile capsule. In some cases, a capsule is squeezed to remove its content. Then, the capsule itself is removed and the content is left at a main container containing the items used to produce the personalized cosmetic product. Next, in step 450, the cosmetic product is manufactured. For example, by mixing the selected items that are the content of the selected capsules. Manufacture may also be provided by addition, heating, cooling, mixing with another material and the like.

The person skilled in the art will appreciate that what has been shown is not limited to the description above. The person skilled in the art will appreciate that examples shown here above are in no way limiting and are shown to better and adequately describe the present invention. Those skilled in the art to which this invention pertains will appreciate the many modifications and other embodiments of the invention. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation. Persons skilled in the art will appreciate that the present invention is not limited to what has been particularly shown and described hereinabove. Rather the scope of the present invention is defined only by the claims, which follow.

1. A production facilitating apparatus enabling manufacturing of at least one cosmetic product or treatment for use by a person, the apparatus comprising,
an input device for receiving data relating to the person,
a processing element for determining the cosmetic product or treatment according to the data relating to the person.

2. The apparatus of claim 1, further comprising a database comprising a list of ingredients used to manufacture the cosmetic product according to the data relating to the person.

3. The apparatus of claim 1, further comprising an output device for notifying the person of the cosmetic product or treatment determined by the processing element.

4. The apparatus of claim 1 wherein the apparatus is adapted to provide at least one list comprising the quantity of the ingredients for manufacturing at least one personal care compound.

5. The apparatus of claim 1 wherein the apparatus is adapted to provide at least one formula for manufacturing a personalized cosmetic compound.

6. A production apparatus for manufacturing a cosmetic product, the apparatus comprising,
a storage containing ingredients used to manufacture the cosmetic product;
an input device receiving a command relating to the ingredients;
a mechanical instrument for removing the ingredients from the storage, such that said ingredients are ready to be used for manufacturing the cosmetic product;
wherein the command is a function of data relating to a person according to which the cosmetic product is manufactured.

7. A production apparatus according to claim 6, wherein the ingredients are stored in capsules within the storage.

8. A production apparatus according to claim 7, wherein the capsules are stored within a cassette, each cassette comprises capsules containing the same ingredients.

9. A method of manufacturing a personalized cosmetic product, said method comprising:
obtaining a predefined list of items;
receiving data relating to a person;
determining at least one item from the list of items to be used in manufacturing the personalized cosmetic product according to the data relating to a person.

10. The method of claim 9, further comprising a step of providing an assessment to the person from which the data is received.

11. The method of claim 9, further comprising a step of receiving user approval of the determined at least one item.
